(19) United States
(12) Patent Application Publication
(10) Pub. No.: US 2004/0054683 A1
(43) Pub. Date: Mar. 18, 2004

(54) System and method for join operations of a star schema database

(75) Inventors: Itaru Nishizawa, Tokyo (JP); Akira Shimizu, Kokubunji (JP)

Correspondence Address: Stanley P. Fisher, Reed Smith LLP, Suite 1400, 3110 Fairview Park Drive, Falls Church, VA, 22042-4503, US

(73) Assignee: Hitachi, Ltd.

(21) Appl. No.: 10/370,504

(22) Filed: Feb. 24, 2003

(30) Foreign Application Priority Data
Sep. 17, 2002 (JP) 2002-269373

(51) Int. Cl. G06F 17/00

(52) U.S. Cl. 707/102

(57) ABSTRACT

For efficiently executing a join in a star schema, a virtual concatenate indexes are stored in a database for defining combinations of a plurality of indexes including at least one of indexes for retrieving corresponding records from a column value on a fact table and one of indexes for retrieving corresponding records from a column value on a dimension table. Indexes indicated by the corresponding virtual concatenate index are sequentially accessed for processing a query which involves a join of the tables. Before processing the query, the virtual concatenate index is materialized. Specifically, a plurality of indexes specified by the virtual concatenate index are joined only within a specified range of column values to point associated records on the fact table, and a set of record IDs of the pointed records are stored corresponding to the column values.

### BACKGROUND OF THE INVENTION

The present invention relates to join operations of a database system, and more particularly, to a method of defining indexes for the join operations, and to a method of executing join operations using the indexes.

Designing of a database for storing data associated with a business system often involves a star schema which is comprised of a fact table for storing sales data (receipt information) added on a daily basis, and dimension tables for defining respective attributes of the fact table. The name “star schema” is derived from the shape of star formed by a plurality of dimension tables arranged about and linked from the fact table. For example, “Database System Implementation” written by Hector Garcia-Molina, Jeffrey D. Ullman, and Jennifer Widom, Prentice Hall, ISBN 0130402648, Section 11.3.3 (Reference 1) discloses the structure and features of the star schema.

The features of the star schema will be described in brief with reference to FIG. 9. In an example illustrated in FIG. 9, the star schema is comprised of a fact table FT (901), and a plurality of dimension tables DT1-DT4 (902-905). Columns c11-c41 on the fact table FT correspond to columns of the same names on the dimension tables DT1-DT4, respectively. Generally, the columns are placed in the relationship of primary keys and foreign keys between the dimension tables and fact table.

An exemplary preferred implementation of the star schema employs the dimension table DT1 for storing data used to manage products, and the fact table FT for storing receipt data used to manage sales of the products at respective stores. When the dimension table DT1 stores data used to manage products, c11, for example, indicates a product ID which uniquely identifies a product, and the columns c12 onward indicate attributes of the product such as a product name, a release day of the product, and the like. Data on the dimension table DT1, used to manage products, is updated at the time a new product is developed and introduced on the market for sales. The fact table FT, in turn, stores receipt data for managing sales at respective stores, so that information is added to the fact table FT each time a product is sold at a store. Thus, the fact table FT is updated highly frequently and in a large scale, as compared with the dimension table DT1.

Information-based systems have been increasingly employed in many enterprises for making a variety of analyses on data stored in course of actual businesses to extract useful information for planning administration strategies. A preferred example of such a system can analyze, for example, product-specific sales at each store in a district A in months to investigate sales strategies at each store on a seasonal basis, thereby directly linking the sales data to the administration strategies to efficiently make decisions.

Since the star schema has been often used for storing actual business data, an improved efficiency has been a challenge in the analyses of data stored in the star schema.

However, when considering the aforementioned sales analysis on a product basis, for example, this analysis requires a join operation of the dimension table DT1 for storing product data, the dimension table DT2 for storing store data, and the fact table FT for storing receipt data with one another for processing data stored therein. Here, the table-to-table join operation refers to the processing for specifying columns through which the tables are joined and join conditions, joining records (rows) which meet the join conditions, and outputting the result. This join operation is quite costly in a database system. Moreover, the join operation in the star schema has not been efficiently carried out because (1) each dimension table can join only with a fact table, and (2) the fact table is immense.

The following three methods are intuitively contemplated for joining, for example, a dimension table DT1 for storing product data, a dimension table DT2 for storing store data, and a fact table FT for storing sales data.

(1) A method of first joining the first dimension table DT1 with the fact table FT, then joining the second dimension table DT2 with the fact table, and joining the resulting tables to produce a final result.

(2) A method of joining the first dimension table DT1 with the fact table FT, and joining the resulting joined table with the second dimension table DT2.

(3) A method of producing a product from the first and second dimension tables DT1, DT2, and joining the product with the fact table FT.

The fact table generally has a very large size. For this reason, the methods (1), (2) join the first dimension table DT1 with the fact table FT to produce excessively large intermediate results which cause a high cost in joining the intermediate results with one another or joining the intermediate results with another dimension table, and extremely low performance.

The method (3), on the other hand, is efficient when a product is produced from a small number of dimension tables and selection conditions for the dimension tables reduces the number of rows on the dimension tables to be joined, because the resulting product should be joined only once with the fact table. However, when a larger number of dimension tables are to be joined, or when dimension tables having large sizes are to be joined, the resulting product suddenly increases, giving rise to extremely exacerbated performance.

U.S. Pat. No. 5,864,842 (Reference 2) discloses a Hash Star Operation (hereinafter “HSJO”) for joining a fact table with a plurality of dimension tables. The HSJO features that the fact table is hash partitioned by join columns, and a plurality of dimension tables are joined at one time. However, since the HSJO involves scanning the fact table when it is hash partitioned by join columns, the HSJO is not available when the fact table is too large to scan the fact table even once.

U.S. Pat. No. 5,960,428 (Reference 3) discloses a join method which is effective when a fact table includes indexes in join columns and dimension tables are tightly narrowed down by conditions. This join method extracts a join column of a selected dimension table, scans the indexes on the fact table with the values in the join column to extract record IDs, repeats the extraction of record IDs for each of selected dimension tables to create a set of record IDs which satisfy the conditions of all the dimension tables, and then joins again the fact table with the dimension tables. The join method disclosed in U.S. Pat. No. 5,960,428 still has plenty of room for improvement of performance in regard with the requirement of scanning the indexes on the fact table with each value in the join column on each dimension table which is to be joined, and the requirement of again joining the fact table with the dimension tables after the fact table has been narrowed down.

U.S. Pat. No. 5,848,408 (Reference 4) discloses Star Transformation which transforms a query such that bitmap indexes on a fact table can be utilized with a value extracted from a dimension table. The Star Transformation, which is performed on the assumption that the bitmap indexes exist on the fact table, can be applied only to a limited range, and entails a very high cost for the maintenance of the bitmap indexes when the dimension tables are updated.

“Administrator's Guide Informix Red Brick Decision Server, Version 6.1,” pp. 4-6-4-8 (Reference 5) discloses a star index mechanism. The star index refers to an index which is created between tables that have references between a primary key and a foreign key, and permits records on a fact table to be searched using values in columns on dimension tables. The star index needs main key/foreign key constraints between the dimension tables and fact table, and entails a high maintenance cost for updating the fact table.

### SUMMARY OF THE INVENTION

For efficiently analyzing data in a business system to effectively utilize the data, a challenge is to efficiently execute the join operation in the star schema. Another challenge is to reduce a database maintenance cost associated with addition and update of data to a database.

It is a first object of the present invention to efficiently execute the join operation in the star schema.

It is a second object of the present invention to provide a mechanism for adjusting the balance between the performance and database maintenance cost in the star schema.

In an exemplary embodiment of the present invention, from indexes respectively provided corresponding to columns on a fact table and dimension tables, which make up a star schema database, for retrieving corresponding records from respective column values, virtual concatenate indexes are defined by a combination of indexes on the fact table, which are to be sequentially accessed for processing a query that requires a join of the tables, and indexes on the dimension tables, and stored in a database. If there is a corresponding virtual concatenate index upon processing the query, a plurality of indexes indicated by the virtual concatenate index are sequentially accessed to identify records on the fact table which meet a condition specified by the query, thereby executing a join operation.

The use of the virtual concatenate index defined by a combination of real indexes effectively reduces the amount of processing upon update of the database. Specifically, for updating the fact table or adding a record, only the real index need be updated in a column on the fact table, while no update is required for the contents of indexes on the dimension tables or the contents of the virtual concatenate indexes.

In another embodiment, prior to the processing of the query, the virtual concatenate index is materialized only within a specified range of column values. Specifically, indexes on the dimension table indicated by the virtual concatenate index are accessed with each of the column values within the specified range, and then indexes on the fact table are accessed using the result to create and store a list of record IDs of records on the fact table which correspond to the respective column values. If a column value specified by a query exists within the specified range upon processing the query, it is possible to point records on the fact table which meet a condition specified by the query only by accessing the materialized virtual concatenate index. Consequently, a query to the star schema database can be processed at an extremely higher speed. In addition, since the virtual concatenate index is partially materialized within a limited range of column values, the index maintenance cost can be reduced upon update and addition of data. More specifically, the virtual concatenate index can be materialized in a variable proportion in accordance with the frequency at which the fact table or dimension table is updated, and the performance required for the join operation, to appropriately control the balance between the performance of the database and the database maintenance cost.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram showing a virtual concatenate index in the present invention;

FIG. 2 shows an example of virtual concatenate index in the present invention;

FIG. 3 is a diagram showing a data access path when using the virtual concatenate index in the present invention;

FIG. 4 shows, as an example, how virtual concatenate index materialization is specified in the present invention;

FIG. 5 is a diagram showing partial materialization of virtual concatenate indexes and exemplary queries in the present invention;

FIG. 6 is a diagram showing, as an example, how a fact table record ID list is created using a virtual concatenate index in the present invention;

FIG. 7 is a diagram showing, as an example, how a column mapping table is created using the virtual concatenate index in the present invention;

FIG. 8 is a flow chart illustrating steps involved in a join operation in the present invention;

FIG. 9 is a diagram showing an example for explaining a star schema;

FIG. 10 is a diagram showing steps involved in executing the join operation using the virtual concatenate index in the present invention; and

FIG. 11 is a block diagram illustrating the configuration of a DBMS in the present invention.

### DETAILED DESCRIPTION OF THE EMBODIMENTS

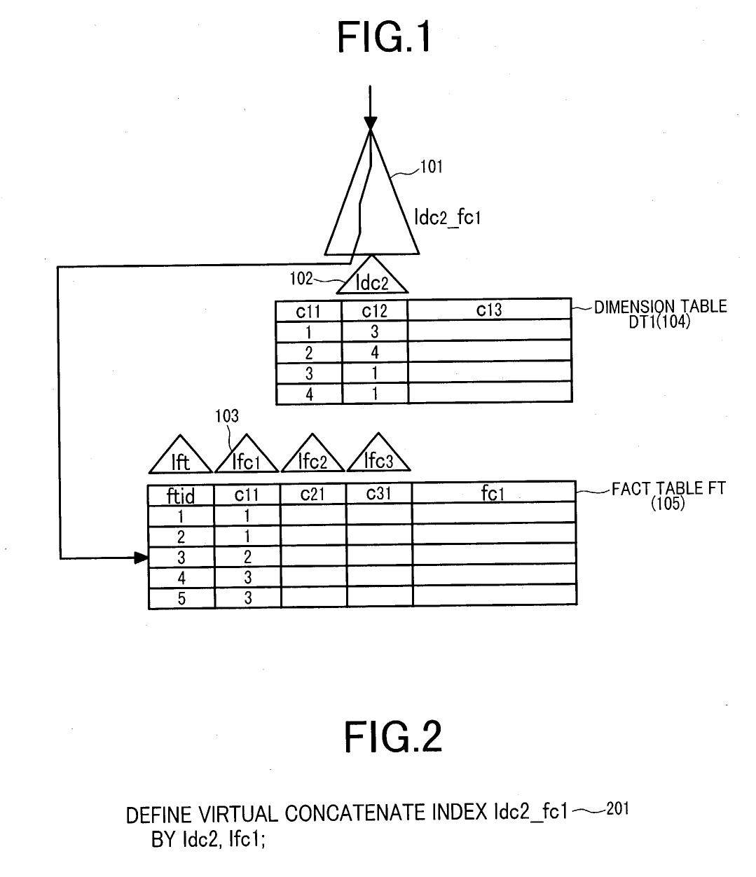

An embodiment of a virtual concatenate index will now be described with reference to FIG. 1. A virtual concatenate index Idc2_fc1 (101) in FIG. 1 is an index with which a fact table FT (105) can be scanned for record IDs from the values in a column c12 on a dimension table DT1 (104). For example, when the fact table FT is scanned with Idc2_fc1 on condition that DT1.c12=4, a record with ftid=3 can be accessed on the fact table FT. The virtual concatenate index of the present invention is defined in combination of existing indexes on a dimension table and a fact table. As a preferred example of the definition, FIG. 2 shows a virtual concatenate index definition statement (201). The definition statement defines the virtual concatenate index Idc2_fc1 in a combination of an index Idc2 (102) on the dimension table DT1 and an index Ifc1 (103) on the fact table.

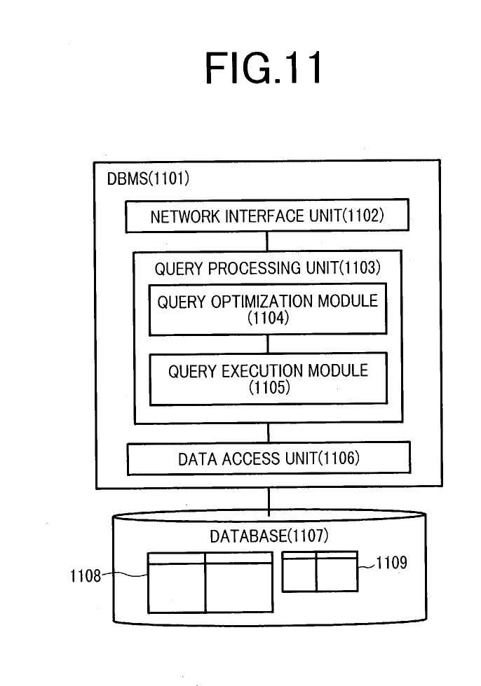

FIG. 11 illustrates the configuration of a database management system (hereinafter abbreviated as the “DBMS”) 1101 in one embodiment of the present invention. A database 1107 is managed by the DBMS 1101. A query to the database 1101 inputted to a network interface unit 1102 through an external network is led to a query processing unit 1103. The query processing unit 1103 includes a query optimization module 1104, such that a query optimized by the query optimization module 1104 is executed by a query execution module 1105. The virtual concatenate index Idc2_fc1 defined by the aforementioned definition statement is stored on a table 1109 within the database 1107 for use in processing a query.

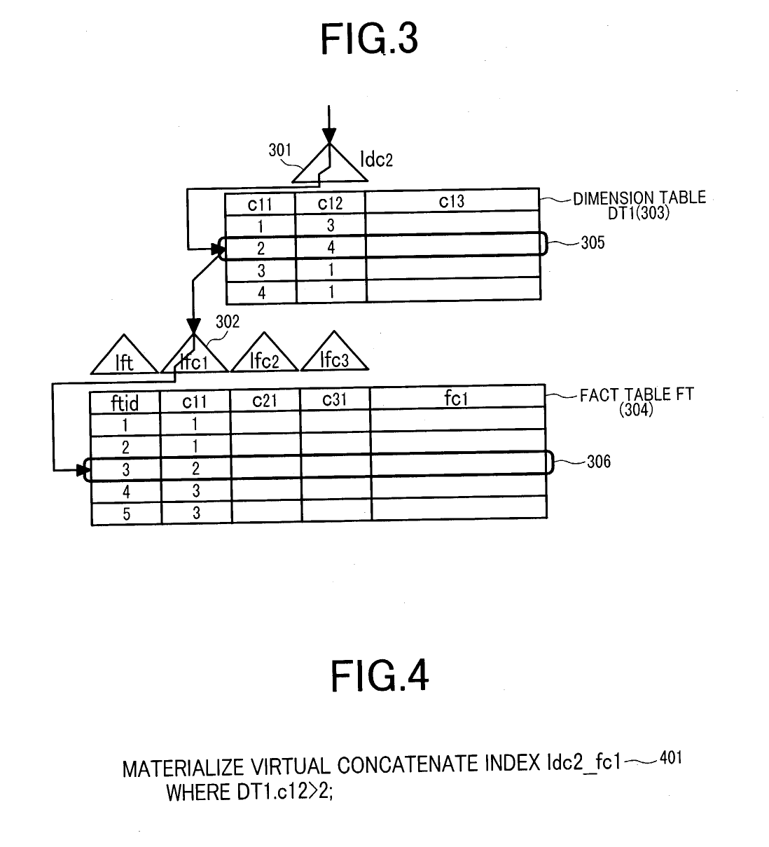

An implementation of a defined virtual concatenate index within the DBMS will be described with reference to FIGS. 3 and 11, giving an example in which a fact table is joined with a dimension table on condition that DT1.c11=FT.c11. For simplification, the following description will be made on a particular operation for joining a record DT1.C12=4 on the dimension table to the fact table. When the virtual concatenate index Idc2_fc1 is accessed on condition that DT1.c12=4, the access is converted to an access to an index Idc2 (301) on the dimension table DT1 (303) and an access to an index Ifc1 (302) on the fact table FT by the query optimization module 1104 in the DBMS 1101.

Generally, a combination of indexes considered upon optimization is found from a limited number of candidates in order to limit a time required for the optimization, which could be prohibitively increased due to an immense number of possible combinations, so that an optimal combination is found with difficulties. In contrast, the query optimization module 1104 can preferentially select appropriate indexes by using the virtual concatenate index definition according to the present invention, thereby reducing not only an execution time but also the optimization time.

In accordance with a combination of indexes determined by the query optimization module 1104, the query execution module 1105 actually accesses the indexes to process the query. Assuming now that Idc2 is accessed on condition that DT1.c12=4, a record 305, which has the value of the column c12 set at “4,” is pointed on the dimension table DT1, and the query execution module 1105 acquires “2” as the value in the column (hereinafter called the “join column”) c11 on the dimension table DT1 which is to be joined with the fact table FT. The query execution module 1105 accesses the index Ifc1 (302) on the fact table FT using c11=2 to acquire a record 306 with the record ID (ftid) set at “3” (ftid=3) on the fact table FT.

While the operation associated with the virtual concatenate index is performed through the foregoing steps, the acquisition of a record on the fact table using the virtual concatenate index involves an access to the index Idc2 on the dimension table DT1, an access to the index Ifc1 on the fact table FT, an access to a data page for acquiring the record 305 on the dimension table DT1, and an access to a data page for acquiring the record 306 on the fact table FT.

When the dimension tables and fact table are updated less frequently so that the index maintenance cost need not be taken into account, or when the system design is primarily intended to improve the reference performance, the virtual concatenate index can be materialized to reduce the cost of acquiring a record on the fact table by accessing the virtual concatenate index. The materialization of a virtual concatenate index involves sequentially accessing indexes which are defined as being concatenated in the virtual concatenate index, prior to execution of a query, and actually storing the result in the DBMS as data, and is comparable to the star index in Reference 5. The materialized virtual concatenate index may be used to improve the execution efficiency because the virtual concatenate index need be accessed only once to point records on the fact table.

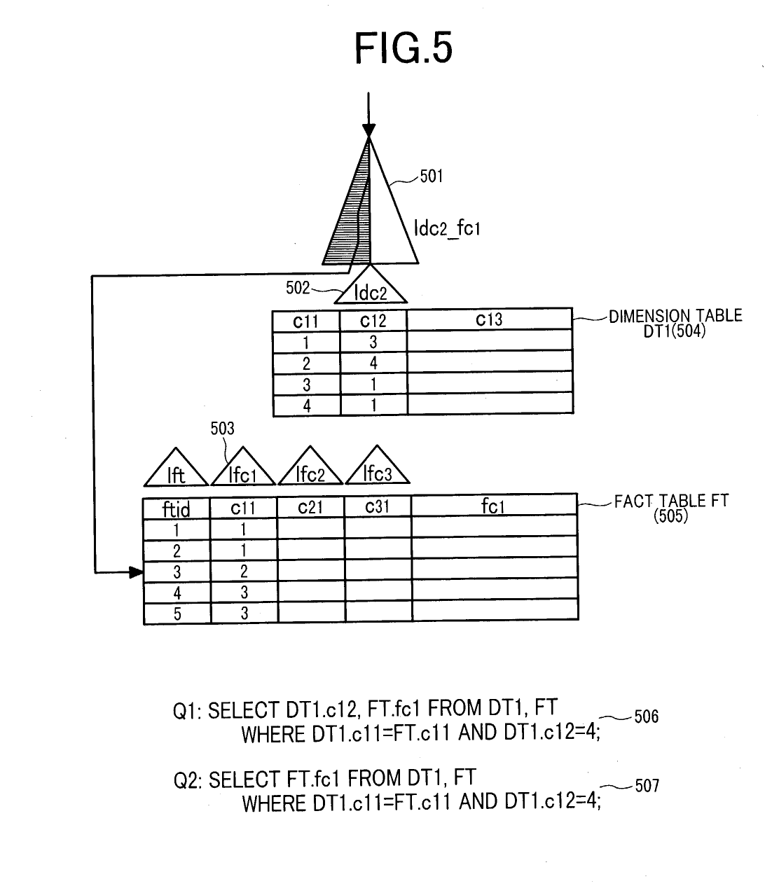

However, the materialization is associated with a significant increase in the index maintenance cost resulting from data modifications, and a requirement for a disk space for storing the materialized indexes. To solve this problem, the present invention enables partial materialization of the virtual concatenate index, as shown in FIG. 5. A virtual concatenate index Idc2_fc1 (501) in FIG. 5 indicates that the shaded left-hand half is materialized, rather than the entirety, so that indexes in a materialized range can be accessed only once to point records on the fact table FT. FIG. 4 shows an exemplary definition of virtual concatenate index materialization, generally indicated by 401. The definition 401 materializes only a portion of the virtual concatenate index Ifc2_fc1 which satisfies DT1.c12>2.

Now, a specific procedure for the materialization will be discussed along the exemplary definition of the virtual concatenation index. In the foregoing exemplary definition, the materialization is limited in a range in which the value in the column c12 is larger than “2” on the dimension table DT1, so that with reference to the indexes 301 of the column c12, the indexes 301 are sequentially scanned for all column values within the limited range (column values “3” and “4” in the example of FIG. 3) to identify associated records. Then, the column values “1” and “2” in the join column c11 are acquired from the identified records, respectively. Next, the indexes 302 to be joined, as defined by the virtual concatenate index, are scanned using the column values in the join column c11 to identify associated records on the fact table FT. The values in the column ftid, which indicate the record IDs on the fact table FT, are read from these records, and the read ftid values are stored in the form of a fact table record ID list which is corresponded to the column values on the dimension table in the limited range. In the example of FIG. 3, ftid=1 and ftid=2 are stored corresponding to the column value “3” in the column c12 of the dimension table DT1, and ftid=3 is stored corresponding to the column value “4.”

When the virtual concatenate index is previously materialized in part as described above, a query, for which the virtual concatenate index is available, is processed by first determining whether or not a column value specified by the query is within a limited range of the materialization definition. When within the limited range, records can be pointed only with a single access to a materialized virtual concatenate index, i.e., by reading the stored fact table record ID list, instead of sequential accesses to respective indexes specified by the virtual concatenate index.

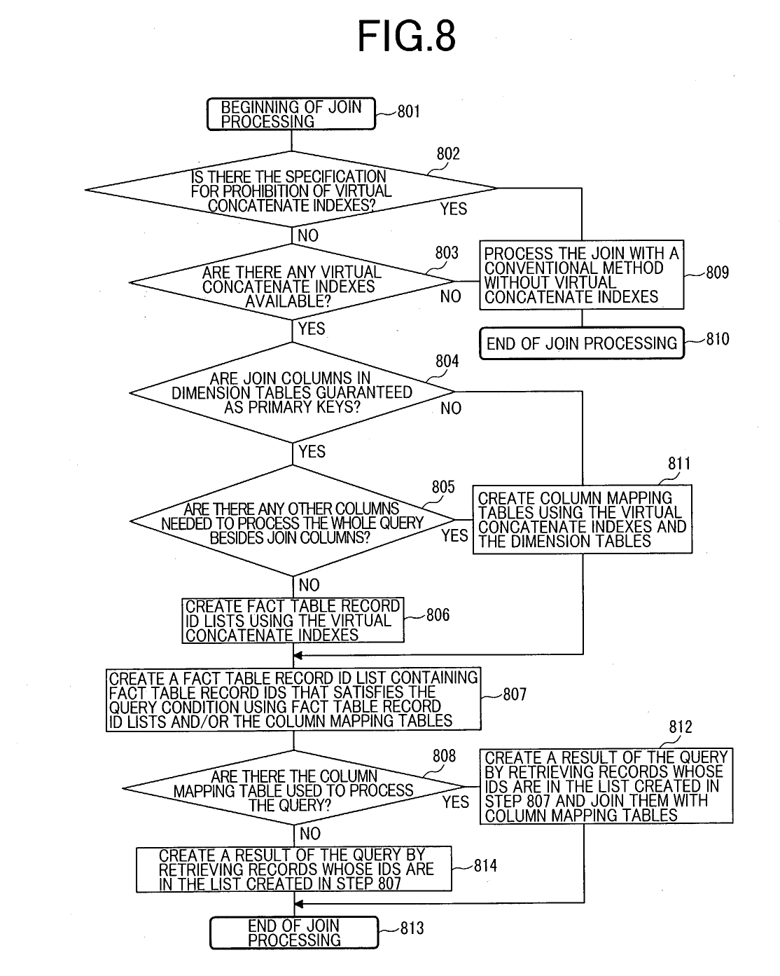

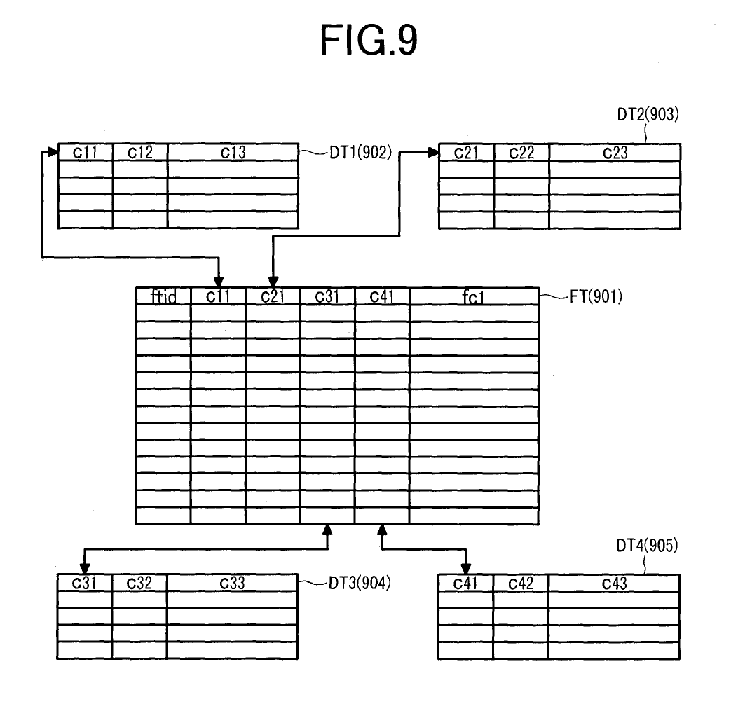

Next, the join operation using the virtual concatenate index according to the present invention will be described with reference to FIG. 8. While the processing illustrated in the flow chart is generally executed by the query optimization module 1104 in the query processing unit 1103 in the DBMS 1101 and the query execution module 1105 in the query processing unit 1103, the processing may be executed by a module different from those depending on the DBMS implementation. In the following embodiment, the join operation is mainly executed by the query processing unit 1103.

At the first step of the join operation, the query processing unit checks whether or not there is a specification for prohibition of virtual concatenate indexes (step 802). If there is the specification for prohibition (Yes at step 802), a conventional join operation is executed without using the virtual concatenate index (step 809), followed by termination of the join operation (step 810). Step 802 may be omitted if virtual concatenate indexes, whenever available, is utilized.

If there is no specification for prohibition of virtual concatenate indexes (No at step 802), the query processing unit checks whether or not any virtual concatenate indexes are available (step 803). If no virtual concatenate indexes are available (No at step 803), a conventional join operation is executed (step 809), followed by termination of the join operation (step 810).

If virtual concatenate indexes are available (Yes at step 803), the query processing unit checks whether or not join columns on dimension tables are guaranteed as primary keys (step 804). The join columns called herein refer to those columns through which two tables are joined. For example, a query 506 in FIG. 5 shows a join condition DT1.c11=FT.c11, so that columns DT1.c11 and FT.c11 are join columns. A column c is a key on a table T when values in the column c are unique, i.e., when the column c does not contain the same value twice or more. For example, on the dimension table DT1 in FIG. 5, since all values in the column c11 are different over the dimension table DT1, it can be said that the column c11 is a key. A DBMS which provides a constraint check mechanism can guarantee that the column c is a key on the table T by applying a unique constraint to the column c on the table T and validating the check mechanism.

If the join columns on the dimension tables are guaranteed as primary keys (Yes at step 804), the query processing unit checks whether or not any other columns are needed to process the whole query besides the join columns after the join operation (step 805). For example, the query Q1 (506) in FIG. 5 specifies DT1.c12 in a SELECT clause, column values are needed besides the join columns to process the query. On the other hand, a query Q2 (507) in FIG. 5 specifies no columns on the dimension table DT1 in a SELECT clause, showing that no columns are needed to process the query after the join operation, so that the join columns are only needed to process the query. The check mechanism for checking which columns are needed after certain processing can be simply implemented by checking columns appearing in a query, and is a known technique supported by many commercial DBMSs.

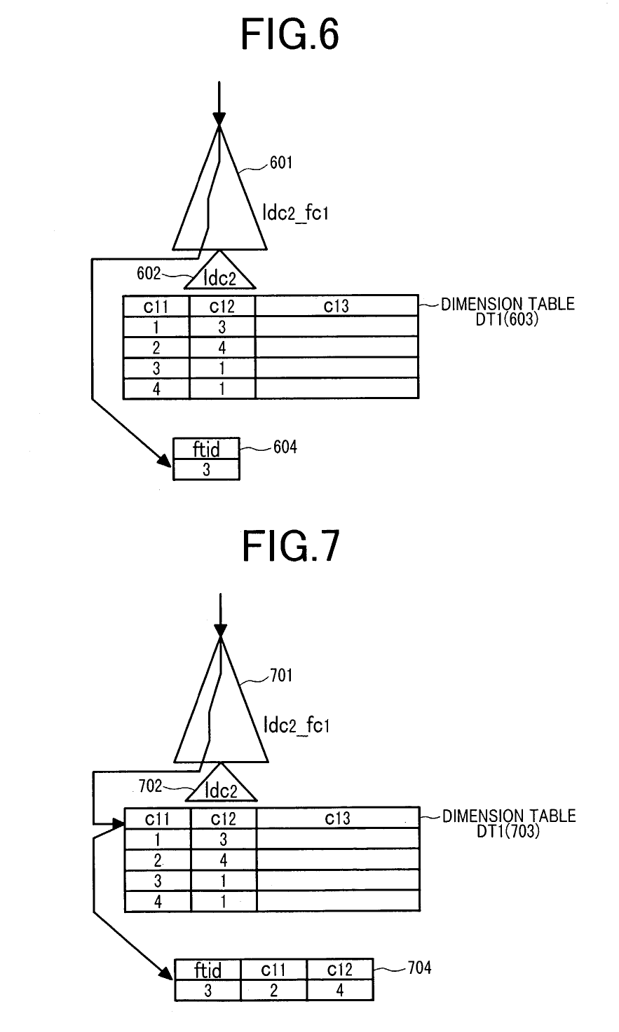

If the join columns are only needed to process the query (No at step 805), fact table record ID lists are created using the virtual concatenate indexes (step 806). The fact table record ID list refers to a list which enumerates record IDs of records which satisfy the join condition, extracted from the fact table FT, as indicated by 604 in FIG. 6. For example, with the query Q2 (507) in FIG. 5, only “3” is stored in the fact table record ID list.

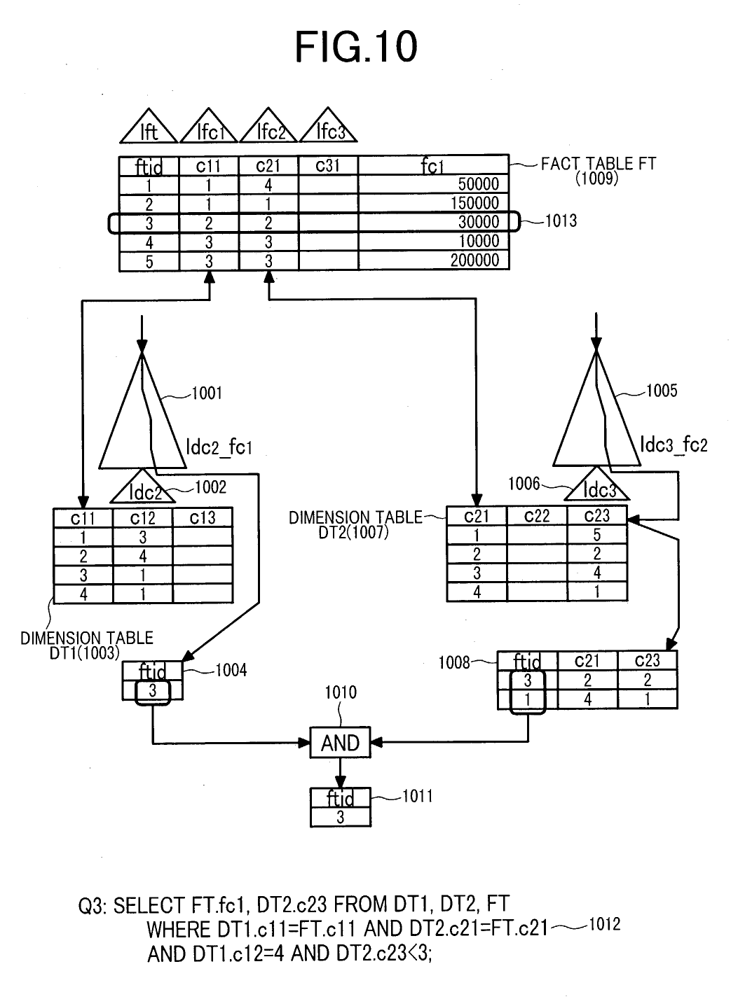

If the join columns on the dimension tables are not guaranteed as primary keys (No at step 804), or if other columns are needed to process the query besides the join columns on the dimension tables (Yes at step 805), column mapping tables are created by using the virtual concatenate indexes and accessing the dimension tables (step 811). The column mapping table refers to a table for storing the record IDs of records which satisfy the join condition on the fact table, the join columns, and columns needed to process the query besides the join columns, as indicated by 704 in FIG. 7. With the query Q1 (506) in FIG. 5, the column mapping table is composed of the record ID of the fact table, the join column c11, and the column c12 needed to process the query. A record stored in the column mapping table is one which satisfies {ftid, c11, c12}={(3, 2, 4)}. After creating the fact table record ID list or column mapping table for each of the dimension tables to be joined, the query processing unit creates a fact table record ID list which contains fact table record IDs of records that fully satisfy the conditions specified by the query (step 807). This processing step will be described with reference to FIG. 10.

In an environment shown in FIG. 10, a database is composed of a total of three tables: a fact table FT (1009) and two dimension tables DT1 (1003), DT2 (1007). Assuming that a query Q3 (1012) is issued to the database, the join operation is required for the tables FT, DT1, DT2 in order to process the query. Join columns through which FT is joined with DT1 and FT is joined with DT2 are c11, c12, respectively. In regard to the join of FT with DT1, since no columns are required to process the query Q3 besides the join column c11 on DT1 after the join operation, a virtual concatenate index Idc2_fc1 (1001) is scanned on condition that FT1.c12=4, as specified in a WHERE clause of the query Q3 to create a fact table record ID list 1004. In regard to the join of FT with DT2, since a column DT2.c23 is specified in a SELECT clause of the query Q3 besides the join column, a virtual concatenate index Idc3_fc2 (1005) is scanned on condition that DT2.c23<3, as specified in the WHERE clause of the query Q3, to create a column mapping table 1008. Since the conditions specified in the WHERE clause of the query Q3 are joined by AND, the fact table record ID list (1004) is joined with a list of record IDs extracted from the column mapping table (1008) by taking AND (1010) to create a fact table record ID list 1011 which enumerates record IDs of records which satisfy the conditions specified by the query Q3.

Turning back to FIG. 8, after creating the fact table record ID list which enumerates record IDs of records which satisfy the conditions, the query processing unit checks whether or not a column mapping table has been created during the processing of the query (step 808). If no column mapping table exists (No at step 808), a result of the query is created by retrieving records on the fact table which correspond to the fact table record ID list created at step 807, because the result of the query can be created only with the fact table (step 814), followed by termination of the join operation (step 813).

When a column mapping table exists (Yes at step 808), a result of the query is created by retrieving records on the fact table which correspond to the fact table record ID list created at step 807 and joining them with the column mapping tables (step 812). For example, in an example of FIG. 10, since the fact table record ID list stores ftid={3} which satisfies the conditions specified by the query, the index Ift is scanned with the value {3} in the ftid on the fact table FT to access a record (1013) with ftid=3, from which the value 30000 in a column FT.fc is extracted since this is specified in the SELECT clause of the query Q3 and needed to process this query Q3. Similarly, a record with ftid=3 is accessed on the column mapping table 1008 to extract therefrom the value “2” in the column DT2.c23 which is specified in the SELECT clause of the query Q3 and needed to process the query Q3. Through the foregoing processing steps, {FT, fc1, DT2, c23}={30000, 2}} can be created as a result of the query Q3.

While the foregoing embodiment has shown a method of holding fact table record IDs in the form of a list, the fact table record IDs may be held in the form of a bitmap. Also, while in the foregoing embodiment, the fact table record ID list is not created for the dimension tables for creating the column mapping table, both the column mapping table and fact table record ID list may of course be created for the dimension tables. Further, the fact table record ID list and column mapping table may be temporarily created on a memory or created as a table (1108) in the database (1107).

As will be appreciated from the foregoing description, the present invention can improve the efficiency of the join operation in the star schema, and appropriately control the balance between the performance of the database and the database maintenance cost.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. A data processing system comprising:
a storage device for storing a star schema database including a first table and a second table which is joined with said first table;
managing means for accepting a query from a client to said database and returning a result of said query to said client;
a first group of indexes for retrieving records on said first table from column values on said first table;
a second group of indexes for retrieving records on said second table from column values on said second table;
a virtual concatenate index for defining a group of indexes which should be sequentially accessed, in a combination of one index in said first group of indexes and at least one index in said second group of indexes; and
a query processing unit responsive to a query from said client which uses said virtual concatenate index for sequentially accessing the group of indexes indicated by said virtual concatenate index to point records which satisfy conditions specified by said query on said first table, and reading said records.

2. A data processing system according to claim 1, wherein said query processing unit comprises means responsive to said query which uses said virtual concatenate index for creating a column mapping table composed of a join column between said first table and said second table, and a column needed to process said query on said second table besides said join column.

3. A data processing system according to claim 1, wherein said query processing unit accesses said join column on said second table to create a record ID list for said first table when said query uses said virtual concatenate index, said join column between said first table and said second table is guaranteed to be a key on said second table, and no column is needed to process said query on said second table besides said join column.

4. A data processing system comprising:
a storage device for storing a star schema database including a first table and a second table which is joined with said first table;
managing means for accepting a query from a client to said database and returning a result of said query to said client;
a first group of indexes for retrieving records on said first table from column values on said first table;
a second group of indexes for retrieving records on said second table from column values on said second table;
a virtual concatenate index for defining a group of indexes which should be sequentially accessed, in a combination of one index in said first group of indexes and at least one index in said second group of indexes;
a materialized virtual concatenate index for providing a list of record IDs on said first table, said materialized virtual concatenate index being created by sequentially accessing the group of indexes indicated by said virtual concatenate index corresponding to each of column values within a previously limited range; and
a query processing unit responsive to a query from said client which uses said virtual concatenate index for sequentially accessing the group of indexes indicated by said virtual concatenate index to point records which satisfy conditions specified by said query on said first table, said query processing unit preferentially using said materialized virtual concatenate index to point records on said first record, and reading the pointed record when a column value indicating a condition specified by said query from said client is within said limited range.

5. A data processing system according to claim 4, wherein:
said first table includes a virtual concatenate index available for processing said query; and
said query processing unit comprises means for accessing said first table and said virtual concatenate index of said first table to create a column mapping table composed of a record ID in said second table, a join column through which said first table is joined with said second table, and a column needed to process said query on said first table besides said join column.

6. A method of processing a join in a star schema database composed of a first table including a first group of indexes for retrieving records from column values and a second table including a second group of indexes for retrieving records from column values, said second table being joined with said first table, said method comprising:
a virtual concatenate index forming step for defining a combination of indexes including one index in said first group of indexes and at least one index in said second group of indexes as a virtual concatenate index and storing said virtual concatenate index;
a query processing step for determining upon receipt of a query to said database whether or not said virtual concatenate index is available, sequentially accessing the indexes in the combination specified by said virtual concatenate index, when available, to point records on said first table, and reading the pointed records.

7. A method of processing a join in a star schema database according to claim 6, further comprising, prior to said query processing step, the step of:
sequentially specifying each of column values within a previously limited range to sequentially access a group of indexes indicated by said stored virtual concatenate index, and storing a list of record IDs on said first table identified by said group of indexes corresponding to each of said column values to materialize part of said virtual concatenate index.

8. A method of processing a join in a star schema database according to claim 7, further comprising the step of:
accessing said materialized virtual concatenate index instead of the sequential accesses to the indexes in the combination specified by said virtual concatenate index when a column value specified by a received query is within said limited range.

9. A method of processing a join in a star schema database according to claim 6, wherein said query processing step includes the step of creating a column mapping table composed of a join column between said first table and said second table, and a column needed to process said query on said second table besides said join column.

10. A method of processing a join in a star schema database according to claim 9, further comprising the steps of:
retrieving a record ID on said second table from said column mapping table to retrieve a column value stored in a record on said second table needed to create a result of said query using said record ID;
retrieving a column value needed to create the result of said query from said column mapping table; and
concatenating said column values to create the result of said query.

11. A method of processing a join of a first table with at least two or more tables to be joined with said first table, said method comprising the steps of:
creating a record ID list enumerating record IDs on said first table, when the record IDs on said first table and a join column through which said first table is joined with said tables to be joined are guaranteed to be keys on said tables to be joined, and when no column is needed to process said query on said tables to be joined besides said join column;
otherwise creating a column mapping table composed of the record ID on said first table, the join column through which said first table is joined with said tables to be joined, and columns needed to process said query on said tables to be joined besides said join column;
retrieving record IDs on said mapping table to create a list of record IDs when said column mapping table exists with respect to said tables to be joined;
applying conditions specified by said query to said list of record IDs and said record ID list, when said record ID list exists with respect to said tables to be joined, to create a resulting record ID list;
retrieving a column value needed to create a result of said query from a record on said first table using said ID;
retrieving a column value needed to create the result of said query from said column mapping table when said column mapping table exists; and
concatenating said column values to create the result of said query.
